(19) United States
(12) Patent Application Publication
(10) Pub. No.: US 2014/0181759 A1
(43) Pub. Date: Jun. 26, 2014

(54) CONTROL SYSTEM AND METHOD USING HAND GESTURE FOR VEHICLE

(71) Applicant: Hyundai Motor Company, Seoul (KR)

(72) Inventor: Sung Un Kim, Yongin (KR)

(73) Assignee: HYUNDAI MOTOR COMPANY, Seoul (KR)

(21) Appl. No.: 14/099,099

(22) Filed: Dec. 6, 2013

(30) Foreign Application Priority Data
Dec. 20, 2012 (KR) 10-2012-0149551

(51) Int. Cl. G06F 3/01

(52) U.S. Cl. CPC G06F 3/017
USPC 715/863

(57) ABSTRACT

A control system and method using a hand gesture for a vehicle are provided. The method includes extracting, by a processor, a hand gesture image from a captured hand image within the vehicle and representing the extracted hand gesture image by overlapping the image on a windshield of the vehicle. In addition, the method includes representing a graphic screen on the windshield and operating devices within the vehicle by manipulating a graphic screen according to the hand gesture image.

### CROSS-REFERENCE TO RELATED APPLICATION

This application claims priority to and the benefit of Korean Patent Application No. 10-2012-0149951 filed in the Korean Intellectual Property Office on Dec. 20, 2012, the entire contents of which are incorporated herein by reference.

### BACKGROUND

(a) Field of the Invention

The present invention relates to a control system and method for a vehicle. More particularly, the present invention relates to a control system and method that uses a hand gesture for a vehicle.

(b) Description of the Related Art

Generally, a display unit is mounted within a vehicle to use a navigation device, a radio, a television (TV), and an Internet system. In addition, a user interface (UI) that controls various functions represented via the display unit provides a direct control method or an indirect control method.

Herein, the direct control method is a type in which a user directly touches a screen, and the indirect control method is a type in which a user controls a screen via an additional controller (e.g., a remote). For the direct control method that uses the touch screen, it is possible for a user to eidetically recognize (e.g., recognize based on an image) the control while directly controlling the screen. However, a user may be distracted when viewing the screen in the direct control method and driving the vehicle at the same time. For the indirect control method, a user may use the additional controller by gripping around the controller and pushing a controller button. In addition, in the indirect method, it may be difficult for the user to recognize the control function since the screen and the controller are separate.

The above information disclosed in this section is only for enhancement of understanding of the background of the invention and therefore it may contain information that does not form the prior art that is already known in this country to a person of ordinary skill in the art.

### SUMMARY

The present invention provides a control system and method that uses a hand gesture for a vehicle having advantages of operating a graphic represented on a windshield using an image of a user's hand gesture.

A control system using a hand gesture for a vehicle according to an exemplary embodiment of the present invention may include a plurality of units executed by a processor. The plurality of units may include an image capturing unit that captures a hand image from within a vehicle; an image treating unit that extracts a hand gesture image from the captured hand image, and represents the extracted hand gesture image by overlapping the image on a windshield of the vehicle; a graphic display unit that outputs a graphic screen on the windshield; and a user interface unit that allows the graphic screen to be manipulated based on the hand gesture image.

The image treating unit may represent the hand gesture image by overlapping the image via the graphic display unit disposed in front of a driver, and the user interface unit may operate the graphic screen of the graphic display unit to be manipulated based on the hand gesture image.

Furthermore, the graphic display unit may be a head-up display (HUD). The graphic display unit may be an audio visual navigation (AVN) system. The user interface unit may execute manipulation such as selecting an icon, flicking, and dragging on the graphic screen represented on the windshield by the hand gesture image.

### BRIEF DESCRIPTION OF THE DRAWINGS

FIG. 1 is an exemplary diagram of a control system using a hand gesture for a vehicle according to an exemplary embodiment of the present invention;

FIG. 2 is an exemplary flowchart showing a process for extracting a hand gesture image and then representing the image according to an exemplary embodiment of the present invention;

FIG. 3 is an exemplary flowchart of a control method using a hand gesture for a vehicle according to an exemplary embodiment of the present invention;

FIG. 4 is an exemplary view showing a hand gesture image projected onto a vehicle windshield via a control system using a hand gesture for a vehicle according to an exemplary embodiment of the present invention; and

FIG. 5 is an exemplary view showing an icon being selected and drag handling being performed in a graphics screen by a hand gesture image according to an exemplary embodiment of the present invention.

Description of Symbols

| | |
|---|---|
| 110: image capturing unit | 120: image treating unit |
| 122: image extracting unit | 124: image display unit |
| 130: graphic display unit | 140: user interface unit |

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will he further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

In the following detailed description, exemplary embodiments of the present invention have been shown and described, simply by way of illustration. As those skilled in the art would realize, the described exemplary embodiments may be modified in various different ways, all without departing from the spirit or scope of the present invention. Accordingly, the drawings and description are to be regarded as illustrative in nature and not restrictive. Like reference numerals designate like elements throughout the specification.

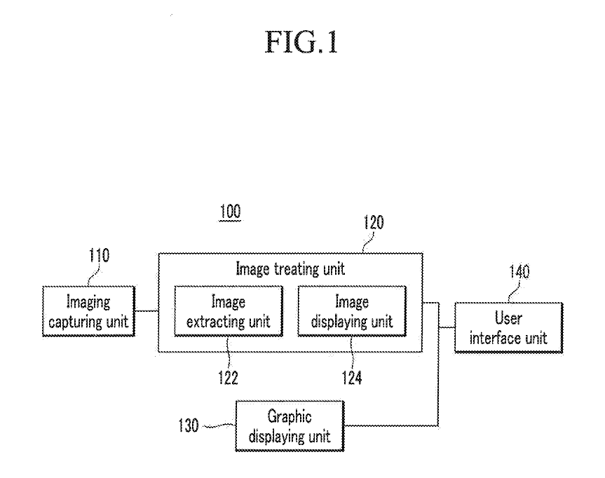

Hereinafter, an exemplary embodiment of the present invention will be described in detail with reference to the accompanying FIG. 1 to FIG. 5.

FIG. 1 is an exemplary diagram of a control system using a hand gesture for a vehicle according to an exemplary embodiment of the present invention. A control system 100 using a hand gesture for a vehicle according to FIG. 1 may include a plurality of units executed by a processor. The plurality of units may include an image capturing unit 110, an image treating unit 120, a graphic display unit 130, and a user interface unit 140.

The image capturing unit 110 may be disposed within a vehicle, and may be configured to capture a hand image inside the vehicle. The image capturing unit 110 according to an exemplary embodiment of the present invention may be a camera, a video device, or the like. In addition, the image capturing unit 110 may include a lighting unit (not shown) that facilitates the capturing of the hand image by emitting light toward the object to be captured.

Further, the image treating unit 120 may be configured to extract only the hand image (hereinafter, hand gesture image) from the image captured by the image capturing unit 110. Further, the image treating unit 120 may be configured to represent the extracted hand gesture image by overlapping the image at the front (hereinafter, windshield) of a vehicle. The image treating unit 120 according to an exemplary embodiment of the present invention may include an image extracting unit 122 and an image display unit 124. The image extracting unit 122 may be a device configured to extract the hand gesture image from the captured hand image. In addition, the image display unit 124 may be a device configured to represent the extracted hand gesture image to overlap the image on a windshield of a vehicle.

As described, the hand gesture image may be displayed on the windshield via the image treating unit 120, and thus a user within a vehicle may eidetically recognize the hand gesture image. Further, the image treating unit 120 may be configured to represent the hand gesture image via an additional device disposed in front of a driver for displaying graphics, and the user interface unit 140 may operate to allow the hand gesture image to control a graphic screen of the additional device.

The graphic display unit 130 may be configured to represent various graphic screens on the windshield. Herein, the graphic screens may be various screens disposed within a vehicle such as screens of a navigation device, a radio, a TV, an Internet and so on. The graphic display unit 130 according to an exemplary embodiment of the present invention may be a head-up display (HUD). In addition, the HUD may represent the hand gesture image directly provided from the image extracting unit 122 of the image treating unit 120 to project the graphic screen together with the hand gesture image. Further, the graphic display unit 130 may be an audio visual navigation (AVN) system.

The user interface unit 140 may be configured to simultaneously represent the hand gesture image and the graphic screen on the windshield, and operate to allow the graphic screen to be manipulated via the hand gesture image. In other words, the graphic screen may be manipulated via the user interface unit 140. Herein, the hand gesture image may perform manipulation such as selecting an icon, flicking, and dragging in the graphic screen represented on the windshield.

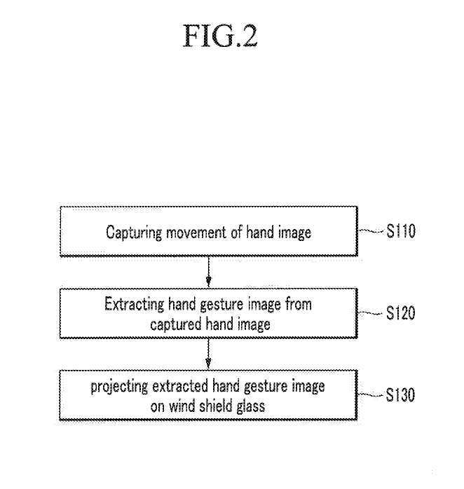

FIG. 2 is an exemplary flowchart showing a process for extracting a hand gesture image and then representing the image according to an exemplary embodiment of the present invention. Referring to FIG, 2, the image capturing unit 110 may be configured to photograph an object at step S110, and the image extracting unit 122 may be configured to extract the hand gesture image from the captured image at step S120. Further, the image display unit 124 may be configured to represent the hand gesture image on the windshield by overlapping the image at step S130.

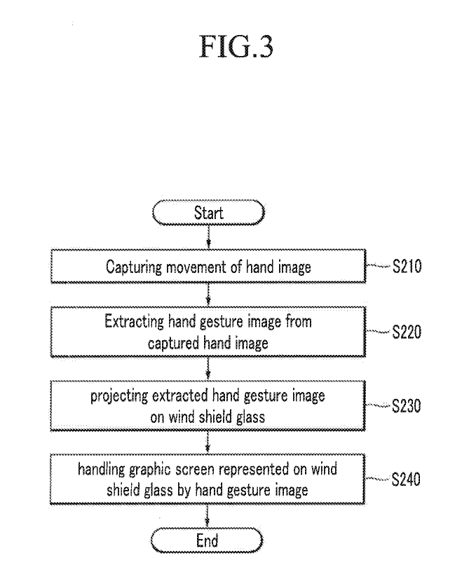

FIG. 3 is an exemplary flowchart of a control method using a hand gesture for a vehicle according to an exemplary embodiment of the present invention. Referring to FIG. 3, a control method using hand gesture for a vehicle according to an exemplary embodiment of the present invention may include capturing, by an imaging device, an image at step S210, treating, by a processor, the image at steps S220 and S230, and operating at step S240.

Specifically, the image capturing unit 110 such as an imaging device (e.g., a camera, a video recorder, etc.) may be configured to capture a hand image within a vehicle at step S210. Herein, in the step S210 according to an exemplary embodiment of the present invention, the object being captured in the image may be lit by the lighting unit. The hand gesture image may be extracted from the captured hand image of step S210, and the extracted hand gesture image may be represented on the windshield by overlapping the image at steps S220 and S230.

Furthermore, the treating of an image at steps S220 and S230 according to an exemplary embodiment of the present invention may include extracting the image and representing the image. First, the hand gesture image may be extracted from the captured hand image at step S220. In addition, the hand gesture image may be represented on the windshield by overlapping the image at step S230. The hand gesture image may be represented on a graphic screen projected from the HUD or the AVN system by overlapping the image in the step S230.

The graphic screen represented on the windshield may be manipulated by the hand gesture image at step S240. In step S240, the hand gesture image may manipulate the graphic screen to select an icon and flicks or drags on the screen in the graphic screen represented on the windshield by the HUD or AVN system. In addition, in the treating of an image at step S220, the hand gesture image may be represented on the additional graphic display unit disposed in front of a driver, and in the operating at step S240, the hand gesture image may manipulate the graphic screen of the graphic display unit.

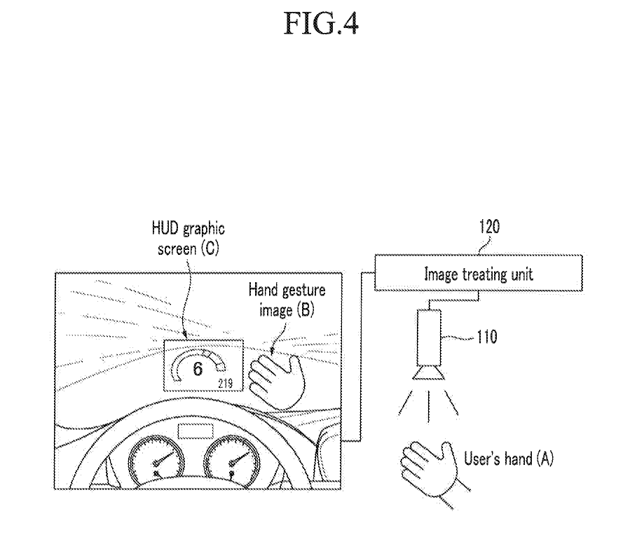

FIG. 4 is an exemplary view showing a hand gesture image projected onto a vehicle windshield via a control system using a hand gesture for a vehicle according to an exemplary embodiment of the present invention. Referring to FIG. 4, an object (A) may be lit by the lighting unit, and the hand image may be captured by the image capturing unit 110. The captured hand image may be extracted and transformed into the hand gesture image (B) by the image treating unit 120, and the extracted hand gesture image (B) may he represented on the windshield.

In addition, the hand gesture image (B) may be in sync with the movement of a user's hand, and may be freely changed based on the movement of a hand image captured by the camera 110. The extracted hand gesture image (B) may be represented together with the graphic screen (C) of the HUD on the windshield by overlapping the images, and the various manipulations in the graphic screen (C) may be performed by the hand gesture image (B).

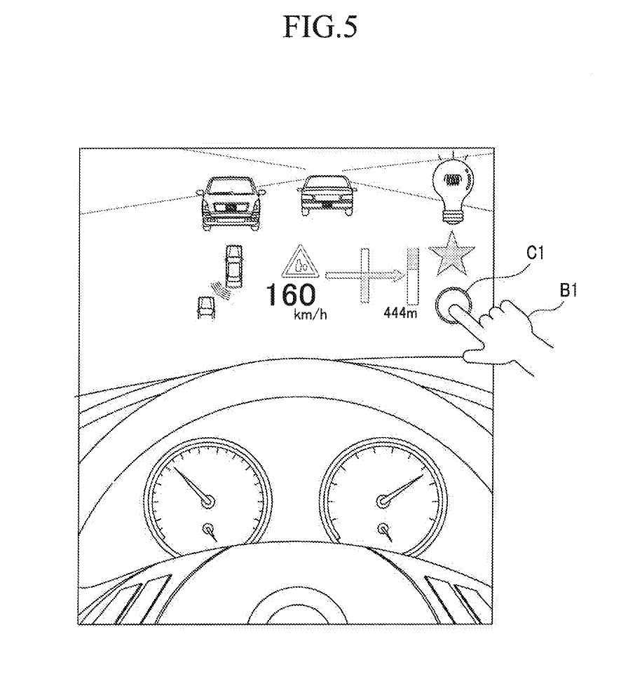

FIG. 5 is an exemplary view showing an icon being selected and drag manipulation being performed in a graphic screen by a hand gesture image according to an exemplary embodiment of the present invention. Referring to FIG. 5, the hand gesture image B1 represented via the image treating unit 120 may indicate selection of an icon C1 of the graphic screen represented on the windshield via the graphic display unit 130. The hand gesture image may indicate a click or a drag of an icon on the graphic screen to operate various functions of the graphic screen.

Therefore, a user may eidetically operate various display devices and a graphic represented on the windshield via the hand gesture image (e.g., via the indication of the hand gesture image) based on the movement of the user's hand such that user's eyes remain focused on the road ahead while driving to ensure driver convenience and safety.

The above-described exemplary embodiment of the present invention can be realized through a program for realizing functions corresponding to the configuration of the exemplary embodiments or a recording medium for recording the program, in addition to through the above-described device and/or method, which is easily realized by a person skilled in the art.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the accompanying claims.

What is claimed is:

1. A control system using a hand gesture for a vehicle, comprising:
a processor and a memory configured to store program instructions and the processor configured to execute the program instructions, the program instructions when executed configured to:
capture a hand image within the vehicle;
extract a hand gesture image from the captured hand image;
represent the extracted hand gesture image by overlapping the image on a windshield of the vehicle;
output a graphic screen on the windshield; and
operate devices within the vehicle based on a manipulation of the graphic screen according to the hand gesture image.

2. The control system of claim 1, wherein the hand gesture image is represented by overlapping the image via a graphic display disposed in front of a driver, and a user interface operates the graphic screen to be manipulated based on the hand gesture image.

3. The control system of claim 2, wherein the graphic display is a head-up display (HUD).

4. The control system of claim 2, wherein the graphic display is an audio visual navigation (AVN) system.

5. The control system of claim 2, wherein the user interface executes manipulation such as selecting an icon, flicking, and dragging in the graphic screen represented on the windshield by the hand gesture image.

6. A control method using a hand gesture for a vehicle, comprising:
extracting, by a processor, a hand gesture image from a captured hand image within the vehicle;
representing, by the processor, the extracted hand gesture image by overlapping the image on a windshield of the vehicle;
outputting, by the processor, a graphic screen on the windshield; and
operating, by the processor, devices within the vehicle based on a manipulation of the graphic screen according to the hand gesture image.

7. The method of claim 6, further comprising:
representing, by the processor, the hand gesture image by overlapping the image via a graphic display disposed in front of a driver.

8. The method of claim 7, wherein the graphic display is a head-up display (HUD).

9. The method of claim 7, wherein the graphic display is an audio visual navigation (AVN) System.

10. The method of claim 6, further comprising:
operating, by the processor, devices within the vehicle via manipulation such as selecting an icon, flicking, and dragging in the graphic screen represented on the windshield by the hand gesture image.

11. A non-transitory computer readable medium containing program instructions executed by a processor, the computer readable medium comprising:
program instructions that extract a hand gesture image from a captured hand image within the vehicle;
program instructions that represent the extracted hand gesture image by overlapping the image on a windshield of the vehicle;
program instructions that output a graphic screen on the windshield; and
program instructions that operate devices within the vehicle based on a manipulation of the graphic screen according to the hand gesture image.

12. The non-transitory computer readable medium of claim 11, further comprising:
program instructions that represent the hand gesture image by overlapping the image via a graphic display disposed in front of a driver.

13. The non-transitory computer readable medium of claim 12, wherein the graphic display is a head-up display (HUD).

14. The non-transitory computer readable medium of claim 12, wherein the graphic display is an audio visual navigation (AVN) system.

15. The non-transitory computer readable medium of claim 11, further comprising:
program instructions that operate devices within the vehicle via manipulation such as selecting an icon, flicking, and dragging in the graphic screen represented on the windshield by the hand gesture image.
